(19) United States
(12) Patent Application Publication
(10) Pub. No.: US 2006/0088630 A1
(43) Pub. Date: Apr. 27, 2006

(54) Process for sonicating plant seeds

(76) Inventors: Eugene J. Fox, Dayton, OH (US); Suhas K. Mehra, Miamisburg, OH (US); Aharon M. Eyal, Jerusalem (IL); Alexander Patist, Maple Grove, MN (US); Eugene M. Peters JR., Kettering, OH (US); Donald L. Shandera JR., Ashland, NE (US)

Correspondence Address: CARGILL, INCORPORATED, LAW/24, 15407 MCGINTY ROAD WEST, WAYZATA, MN, 55391, US

(21) Appl. No.: 10/521,077

(22) PCT Filed: Jul. 22, 2003
(86) PCT No.: PCT/US03/22964

§ 371 Date: Aug. 17, 2005

Related U.S. Application Data
(60) Provisional application No. 60/397,674, filed on Jul. 22, 2002.

(51) Int. Cl. A23L 3/30

(52) U.S. Cl. 426/238

(57) ABSTRACT

There is described a process for sonicating a plant seed at an intensity of at least 95 W/cm² and a frequency ranging from about 16 to 100 kHz. Also disclosed is a process for using the sonicated plant seed for production of either a starch product or a fermentation feedstock. Also disclosed is the use of the sonicated plant seed as a fermentation feedstock.

This application claims priority of Provisional Application Ser. No. 60/397,674, filed Jul. 22, 2002, the entire contents of which are incorporated herein by reference.

### FIELD OF INVENTION

The present invention relates to sonicating plant seeds, and using the sonicated plant seeds in the production of starch and fermentation feedstock.

### BACKGROUND

Plant seeds have an outer layer structure called the testa, also commonly termed between different plant types as the pericarp, bran, fiber, hull, seedcoat, shell, and the like. In many food and industrial uses, plant seeds are processed to separate the testa from other seed components by processes such as wet milling, dry milling, or pearling.

Most corn processed in the United States is treated by the wet milling process. This process includes a 24-48 hour chemical steeping of the corn followed by grinding, filtration, and high-speed centrifugation using copious amounts of water to separate fiber, germ, protein, and starch. Traditionally, the germ is subsequently processed to vegetable oil, and the protein and fiber are used for animal, avian, or fish feed, and the starch is used for many purposes such as sweetener or alcohol production.

In several industries dehulling or debranning to remove the testa layers from plant seeds is a critical operation for increasing the palatability of seeds for human and animal food uses and increases their storability and value. Such an example of debranning operations is dry milling used in the production of wheat flour and dehulling of rice for the production of white rice. These processes often have great processing losses and difficulties in separation and/or purifying the hull or testa from other seed component streams. Additionally, these processes are often expensive to operate and/or may induce undesirable damage to the seed material.

Dehulling or loosening of testa layers are required for many horticultural applications. Typically, loosening is induced by methods such as abrasive scarification to reverse the quiescence of seeds and induce germination. Such applications increase oxygen and water permeability to the seed.

### SUMMARY OF THE INVENTION

The present process comprises sonicating a plant seed in the presence of solvent at an intensity of at least 95 watts per square centimeter (W/cm²), preferably about 100 to about 500 W/cm², and at a frequency ranging from about 16 to about 100 kilohertz (Hz). Optionally, the sonicated plant seed may be further sonicated at an intensity of at least 95 W/cm² and at a frequency ranging from about 16 to about 100 kHz.

The present process also relates to using a starch-containing plant seed sonicated at an intensity of at least 95 W/cm² and at a frequency ranging from about 16 to about 100 kHz in the production of a starch product. In this instance, there may also be used a sonicated plant seed that is additionally sonicated at an intensity of at least 95 W/cm² and at a frequency ranging from about 16 to about 100 kHz.

The present process also relates to the use of the sonicated plant seeds as a fermentation feedstock. The present process is further related to using a plant seed sonicated at an intensity of at least 95 W/cm² and at a frequency ranging from about 16 to about 100 kHz in the production of a fermentation feedstock. In this instance, there may also be used a sonicated plant seed that is additionally sonicated at an intensity of at least 95 W/cm² and at a frequency ranging from about 16 to about 100 kHz.

### DETAILED DESCRIPTION OF THE INVENTION

In a first embodiment, the present process comprises sonicating a plant seed in the presence of solvent at an intensity of at least 95 watts per square centimeter (W/cm²), preferably about 100 to about 500 W/cm², and at a frequency ranging from about 16 to about 100 kilohertz (kHz). Optionally, the sonicated plant seed may be further sonicated at an intensity of at least 95 W/cm² and at a frequency ranging from about 16 to about 100 kHz.

The present process also relates to using a starch-containing plant seed sonicated at an intensity of at least 95 W/cm² and at a frequency ranging from about 16 to about 100 kHz in the production of a starch product. In this instance, there may also be used a sonicated plant seed that is additionally sonicated at an intensity of at least 95 W/cm² and at a frequency ranging from about 16 to about 100 kHz.

The present process also relates to the use of the sonicated plant seeds as a fermentation feedstock. The present process is further related to using a plant seed sonicated at an intensity of at least 95 W/cm² and at a frequency ranging from about 16 to about 100 kHz in the production of a fermentation feedstock. In this instance, there may also be used a sonicated plant seed that is additionally sonicated at an intensity of at least 95 W/cm² and at a frequency ranging from about 16 to about 100 kHz.

In further detail, the plant seed that is sonicated in the present invention may be any plant seed. Examples of plant seed suitable for use in the present process include a cereal such as corn (maize), rice, sorghum, barley, wheat, and the like; oil seeds such as soybean, peanut, rapeseed (canola), cottonseed, safflower, sunflower, linseed (flax), caster bean, and the like; and any other plant seeds including nuts, pinto beans, peas, grasses, and the like.

In the present process, the plant seed is sonicated in the presence of a solvent. As solvent, there may be used any aqueous or organic solvent(s) or mixtures thereof. Examples of organic solvents include methanol, ethanol, butanol, propanol, iso-propanol, hexane, isohexane, acetone, dimethylformamide, dimethyl sulfoxide, and the like. Preferred for use, however, is an aqueous solvent such as water. The solvent may also include other chemical and/or biological reagents such as surfactants, acids, bases, reducing agents, enzymes and other reagents known by those skilled in the art. Examples of reducing agents include sulfur dioxide, salts of bisulfite, mercaptoethanol, thioglycolic acid, and dithiothreitol. Examples of suitable acids include lactic acid, acetic acid, and sulfuric acid. Examples of suitable bases include calcium hydroxide, sodium hydroxide, and potassium hydroxide. The plant seed in the present process is contacted with the solvent utilizing any technique suitable for achieving the contact. For example, the contacting may be carried out by mixing, immersing, soaking, spraying or misting. The solvent may be added simultaneously with the plant seed to the sonication process. Additionally, the plant seed may be exposed to the solvent prior to the sonication process. Moreover, the contacting may be carried out either batch wise or continuously.

In this process the plant seed is sonicated at an intensity of at least 95 W/cm² and at a frequency of about 16 to about 100 kHz, and more preferably at a frequency of about 20 to about 60 kHz. As used herein, sonicating refers to affecting or treating the plant seed with sound waves at an intensity of at least 95 W/cm² and at a frequency of about 16 to about 100 kHz. With respect to the intensity of the sound waves, there is no maximum limit. However, preferably, the intensity of the sound waves range from at least 95 W/cm² to about 500 W/cm². The sound waves that propagate outward from the radiating surface may be created and applied by vibrating a diaphragm or solid object in a solution rapidly. The sound waves may be created and applied by any method known to those skilled in the art, including piezoelectric effect.

In a second embodiment, a starch-containing plant seed that is sonicated at an intensity of at least 95 W/cm² and at a frequency of about 16 to about 100 kHz in the present process under the conditions specified, is useful in the production of a starch product. Any wet processing or wet milling process for treating a starch containing plant seed may be utilized in the present process for producing a starch product from a sonified starch-containing plant seed. Wet processing of a starch containing plant seed may be defined as processing a starch containing plant seed wherein an amount of water exceeding the amount that can be absorbed by the starch containing plant seed is used to enhance separation of the components of the starch containing plant seed.

For the purposes of this application, wet milling of a starch-containing plant seed will be described herein in relation to the wet milling of corn. Wet milling of corn may be defined as processing corn wherein an amount of water exceeding the amount that can be absorbed by the corn is used to steep and mill the corn. Steeping of the corn may be carried out in any conventional manner. The steeping and wet milling of corn will provide a concentrated starch product.

An exemplary process for carrying out the wet milling process to produce a starch product is described as follows: Corn is optionally cleaned using a series of perforated screens of a size suitable to retain the corn and to allow removal of dust and debris. The corn is introduced into a steeping battery typically consisting of 6 to 30 steep tanks containing corn and water. These tanks are typically interconnected by waterflow that moves in a counter current direction to the corn. The corn is steeped 20-48 hours, typically, at a temperature of 46-55° C. (115-132° F.). During steeping the corn absorbs water and sulfur dioxide or salts of sulfite. The oldest water in the steep battery, that is rich in corn solubles, is drawn off and concentrated by evaporation into a corn steep liquor product. The oldest corn in the battery is then milled. Once steeping has been completed, the solvent is drained from the corn, a sufficient amount of water or other solvent is added to the corn and the corn is coarse ground using an attrition, impact, or similar mill to break the corn kernel pericarp and liberate the germ. Germ is density separated from the ground corn material using hydrocyclones. Corn oil can be purified from the germ by pressing and/or with solvent extraction. The remaining corn material is then fine ground using an attrition, impact, or similar mill. Fiber is then removed using screens, dewatered using presses, and dried using a rotary drier, resulting in the dried fiber product. The remaining slurry is primarily starch and protein, which are separated by centrifugation using a nozzle-discharge disk stack centrifuge. The protein enriched portion, also known as gluten, from this centrifugation is then further concentrated by centrifugation, dewatered on a rotary drum filter and dried using a flash drier. This results in the protein rich product that is the gluten meal. The starch enriched portion of the protein/starch centrifugation step is then washed in a hydrocyclone battery to yield a starch enriched product stream.

In the present invention starch is defined as material originating from the wet milling process that contains, at least partially, starch. This may be either a product or intermediate stream.

Further information regarding the wet milling process is found in Corn: Chemistry and Technology pp. 377-397, Stanley A. Watson and Paul E. Ramstad, ed.

In a third embodiment, the present process is also related to utilizing the plant seed sonicated in accordance with the present invention under the conditions specified herein, at an intensity of at least 95 W/cm² and at a frequency of about 16 to about 100 kHz, in the production of fermentation feedstock. The fermentation feedstock is obtained by subjecting the sonicated plant seed to any conventional process such as wet milling or wet processing to obtain a concentrated starch and/or protein product that can be used as a feedstock for fermentation. In a further embodiment, the concentrated starch and/or protein product may be further subjected to chemical and/or enzymatic hydrolysis and be utilized as such, as a feedstock for fermentation.

As an example of a method for producing a fermentation feedstock, the following is provided. The starch slurry produced by the previously described wet milling process may be optionally hydrolyzed. The starch slurry may be hydrolyzed by any conventional manner. For example, starch slurry may be hydrolyzed by subjecting the starch slurry to acid hydrolysis. Typically acids will include inorganic acids such as hydrochloric acid and the like. Elevated temperatures increase the rate of hydrolysis and may be varied over a wide range depending on the degree of hydrolysis desired. Acid hydrolysis is limited in the extent of starch hydrolysis possible. If one wishes to exceed that level of hydrolysis, one must use other means of hydrolysis such as enzymatic digestion of the starch with starch hydrolyzing enzymes.

In exemplary process for carrying out starch hydrolysis by acid hydrolysis is described as follows:
a) starch slurry is acidified by adding an acid such as hydrochloric acid and holding at elevated temperatures for a period of time, and depending on the specific conditions utilized, a range of hydrolysis products may be made;
b) the resulting insoluble solids from hydrolysis may optionally be removed by drum filtration;
c) the resulting hydrolysate may optionally be further purified by carbon and/or ion exchange treatment; and
d) the resulting hydrolysate may optionally be further concentrated by evaporation.

An exemplary process for starch hydrolysis by enzyme/enzyme hydrolysis is described as follows:
a) the starch is liquefied by treatment with alpha amylase enzyme and jetted at high temperature and pressure, continuing to hold the starch at elevated temperature;
b) the starch is then further digested with a combination of glucoamylase and pullulanase enzymes;
c) the resulting insoluble solids from hydrolysis may optionally be removed by filtration;
d) the resulting hydrolysate may optionally be further purified by carbon and/or ion exchange treatment; and
e) the resulting hydrolysate may optionally be further concentrated by evaporation.

In the present invention any enzyme capable of hydrolyzing a plant seed and plant seed component may be used. Examples of grain hydrolyzing enzymes include starch hydrolyzing enzymes (for example amylases, glucoamylases, pullulanases), protein hydrolyzing enzymes (for example proteases, peptidases), fiber hydrolyzing enzymes (for example cellulases, xylanases) and phytate hydrolyzing enzymes (for example phytases).

Further information regarding the hydrolysis of starch is found in Corn: Chemistry and Technology pp. 518-521, Stanley A. Watson and Paul E. Ramstad, ed.

In the present process when the plant seed is sonicated at an intensity of at least 95 W/cm² and a frequency of about 16 to about 100 kHz, the testa of the plant seed is loosened and/or separated from the plant seed. As used herein, the term testa is used to describe one or more outer structures of the plant seed including structures commonly termed the seedcoat, pericarp, fruit coat, bran, fiber, hull, shell, and the like. Thereafter, the plant seed is separated from the testa by any conventional means (for example hammer milling, attrition milling), and the plant seed and the testa may be purified and recovered by any conventional means (for example aspiration, hydrocyclones, gravity tables).

In the present process when the plant seed is sonicated at an intensity of at least 95 W/cm² and a frequency of about 16 to about 100 kHz, a product resulting from sonication of the plant seed (for example a protein, carbohydrate, vitamin, antioxidant, pharmaceutical, oil) is loosened, released, extracted, and/or separated from the plant seed. Thereafter, the product may be recovered and purified from the plant seed by any conventional means (for example filtration, solvent extraction, distillation, precipitation, flotation).

The following examples are presented to illustrate the present invention and to assist one of ordinary skill in making and using the same. The examples are not intended in any way to otherwise limit the scope of the invention.

### EXAMPLES

In carrying out the following example, the following test procedure was used. Corn is selected as the exemplary plant seed.

Percent Pericarp Released from Corn

This is a procedure for determining the percentage pericarp released during grinding of the corn. In carrying out the procedure the following is done:

a) Pericarp Release by Grinding:

The corn was ground using a Quaker City, 4 inch plate mill, model no. 4-E (The Straub Co., Warminster, Pa.). The plates were set with a gap of 6.2 millimeters (0.244 inch). The corn was ground without the addition of water. The ground corn was then spread on a tray and freed pericarp was hand separated from the ground material. The pericarp was dried in a vacuum oven at 80° C. and at −25 mmHg for 24 hours. Dried mass was then determined.

b) Total Pericarp Content

Quantification of the total pericarp content of corn was determined by soaking corn in a 2000 ppm sulfur dioxide and 1% w/w lactic acid solution at 50° C. for 15 hours. The corn was drained and then the pericarp was manually peeled off the corn. The pericarp was dried in a vacuum oven at 80° C. and at −25 mmHg for 24 hours. Dried mass was then determined.

c) Calculation of Pericarp Released by Grinding
% pericarp released=((mass of released pericarp from the ground corn)/(mass of total pericarp))×100

### Example 1

A yellow #2 dent corn was cleaned over a #4 U.S. wire (7.5 millimeter opening) sieve to remove broken kernels and chaff. Physically or heat damaged kernels were removed.

75 grams of corn having a 15% moisture content was soaked for 30 minutes at 50° C. in 200 grams of steep water containing 2000 ppm sulfur dioxide and 1% (w/w) lactic acid. The mixture of corn and steepwater was transferred to a 500 ml jacketed vessel with temperature maintained at 50° C. The mixture of soaked corn was stirred to keep the kernels in suspension. The mixture was treated for 20 minutes with a Model # UP 400 S ultrasonic processor available from Hielscher Corporation, Berlin, Germany, with an axial probe operating at a frequency of 24 kHz and at various intensities upto 127 W/cm² (shown in Table 1). The percent pericarp released is measured using the method of % Pericarp Release from Corn.

TABLE 1
Pericarp Released from Corn

| | | Increase in the Pericarp |
|---|---|---|
| Sonication Treatment | Pericarp Released | Release over the Control |
| Intensity (W/cm2) | (%) | (%) |
| No Sonication^{a} | 14.67 | n/a |
| 25 | 14.96 | 2 |
| 90 | 13.8 | −6 |
| 95 | 19.87 | 35 |
| 101 | 30.88 | 110 |
| 108 | 34.27 | 134 |
| 127 | 37.3 | 154 |

^{a}Control (30 min soak and 20 min stir)

From the above data in Table 1, it was observed that sonication at a frequency of 24 kHz and intensities up to 90 W/cm², produced substantially no increase in pericarp release as compared to the control that was not sonicated. However, unexpectedly and surprisingly, it has been found that sonication of the corn at a frequency of 24 kHz and at an intensity of 95 W/cm² and greater results in a significant increase in the amount of pericarp released from the corn, as compared to the control that was not sonicated. The data shows pericarp release increases ranging from 35%, at an intensity of 95 W/cm², to 154% at an intensity of 127 W/cm².

### Example 2

The procedure of example 1 is followed except that soybean was substituted for the corn and the sound wave generated by the ultrasonic processor is at a frequency of 50 kHz and an intensity of 150 W/cm². It is expected that similar results will be obtained.

### Example 3

The procedure of example 1 is followed except that rice is substituted for the corn and the sound wave generated by the ultrasonic processor is at a frequency of 20 kHz and an intensity of 300 W/cm². It is expected that similar results will be obtained.

### Example 4

The procedure of example 1 is followed except that caster bean is substituted for corn, ethanol is substituted for the steepwater, and the sound wave generated by the ultrasonic processor is at a frequency of 80 kHz and at an intensity of 100 W/cm². It is expected that similar results will be obtained.

### Example 5

The procedure of example 1 is followed except that hexane is substituted for the steepwater. It is expected that similar results will be obtained.

### Example 6

The procedure provided in Example 1 is performed using greater than 95 W/cm² intensity. Pericarp (fiber) is removed from the sample and the sample can be then further processed to produce a starch-containing product.

The starch-containing product is obtained by treating 200 grams of a pericarp depleted sample prepared as described above with 300 mL of an aqueous solution in 500 mL sealed jar. The aqueous solution contains 2000 ppm sodium bisulfite and 1% (w/w) lactic acid. The pericarp depleted sample is soaked (steeped) at 50° C. for 12 hours in the jar. The steeped pericarp depleted sample is divided into 2 equivalent volume fractions. Each fraction is ground separately with 220 milliliters of added distilled water using a model 700S Waring blender, available from Waring Laboratory, Torrington, Conn. The Waring blender is is fitted with the standard 1 liter sized stainless steel blender jar with its cutting blades reversed so that the blunt side of blade impacts the corn. The blender is operated at 3000 revolutions per minute for 2 minutes, then at 4000 revolutions per minute for 2 minute for each corn fraction ground separately. The two ground fractions are then commingled in a 1-liter beaker and stirred to allow the germ to float to the top of the ground mixture. Floating germ is skimmed by hand with a 12 mesh (1.70 millimeter opening) wire screen. Skimmed germ is placed on a #12 U.S. wire (1.70 millimeter opening) sieve and washed with 1 liter of distilled water of which the used wash water is saved for adding back to slurry during bran separation. Degermed slurry is then ground in a Quaker City 4 inch grind mill, model no. 4-E, Straub Co., Warminster, Pa., with the grinding plates adjusted to contact each other. The ground slurry is then consecutively-sieved over a #60 (250 micrometer opening) and #325 (45 micrometer opening) U.S. wire sieves to separate bran (fiber) from the starch and protein in the slurry. Bran is washed with an additional 2 L of distilled water and the 1 L of water saved during the previous germ washing step. The solids of the degermed and debranned protein-starch slurry are allowed to settle at room temperature for 1 hour. A quantity of liquid is decanted from the settled protein-starch slurry such that a 5.5 Baumé slurry is produced upon re-suspension of the settled starch and protein solids. Starch is then separated from protein by tabling the 5.5 Baumé adjusted protein-starch slurry. The aforementioned decanted volume is set aside for further usage in washing starch. The protein-starch slurry is pumped at a rate of 50 milliliters per minute onto a 0.0508 meter wide by 2.44 meters length (2 inch by 8 feet long) aluminum table inclined 0.0254 meter (1 inch) at the feeding end of the table. After the 5.5 Baumé protein-starch slurry is finished pumping onto the table, the approximately 3 liters of previously decanted water that had been set aside is consecutively pumped onto the feeding end of the table at a rate of 50 milliliters per minute. Subsequently, an additional 1 liter fresh distilled water is pumped onto the feeding end of the table at a rate of 50 milliliters per minute to wash the starch settled onto the table. The starch is then collected.

### Example 7

The procedure of example 6 for the production of starch from a starch containing seed is followed except sound wave generated by the ultrasonic processor is used to treat the starch containing seed instead of grind mills. After steeping, the steeped seed is passed through a cylinder fitted with multiple ultrasonic processor radial probes operating at a frequency of 30 kHz and an intensity of 300 W/cm². Starch, protein, germ and fiber are separated by subsequent operations as indicated in Example 6.

### Example 8

Corn is cleaned using a series of perforated screens of a size suitable to retain the corn and to allow removal of dust and debris. Clean corn is steeped in an aqueous solution originating from process water used in the mill containing 1800 ppm of sulfur dioxide (802) at 49° C. (120° F.) for 30 hours in a heated tank. The steeped seed is passed through a cylinder fitted with multiple ultrasonic processor focused probes operating at a frequency of 25 kHz and an intensity of 200 W/cm². The sonified corn is dewatered over 150 micrometer dewatering screens and ground in a 91 cm (36 inch) grind mill fitted with fluted plates with a gap setting of about 6.2 millimeters (0.244 inch) operating at 400 rpm. The sonication treated corn is further steeped in an aqueous solution originating from process water used in the mill containing 1800 ppm of SO₂, at 49° C. (120° F.) for 30 hours in a heated tank. Approximately, 1.2 m³ of the aqueous solution is used per metric ton of corn (8 gallons of aqueous solution/bushel of corn) being steeped. After 30 hours of steeping, the corn and the aqueous solution are recovered as the steeped corn and light steep water product of steeping, respectively. The steeped corn product is ground in the presence of mill process water. Grinding of the steeped corn is performed in three stages. The first stage (herewith referred to as 1st grind) releases most of the germ from the steeped corn using a 91 cm (36 inch) grind mill fitted with Devil's toothed plates operating at 900 rpm. The slurry discharge from the 1st grind mill is pressure fed at approximately is 6.2 bars (90 psi) through a two-pass hydrocyclone battery consisting of 15.24 cm (6 inch) hydrocyclones to separate the germ. The separated germ is washed with mill process water and dried in a rotary drum drier to yield a dried germ product. The remaining slurry from which most germ has been separated is milled again, coarsely ground using a second 91 cm (36 inch) grind mill (herewith referred as second grind) fitted with Devil's toothed plates operating at 900 rpm to detach remaining germ from ground corn in the slurry. Freed germ present in the second grind discharge slurry is separated and recovered using hydrocyclones as described above. After the removal of germ, the remaining corn material is passed over 50 micron screen (referred to as third grind dewatering screen). The filtrate containing starch-protein moves forward, while the corn material retained as overs by the screen is fine ground using a 36 inch grind mill (herewith referred as third grind) fitted with Devil's toothed plates operating at 1800 rpm. The fiber component in the slurry of the third grind discharge is removed by a seven stage screen separation system arranged such that the fiber is washed in a counter current flow of fiber to mill process water, where the cleanest fiber is washed with the mill process water added to the screen system. Washed fiber is discharged at the last stage (seventh stage), while starch and protein-containing slurry is discharge at the first stage. The screen opening on the first fiber wash stage is 50 micrometer, followed by 75 micrometer on the second through sixth stage and 150 micrometer of the last stage. The washed fiber is dewatered using screw presses, and dried using a rotary drier, resulting in the dried fiber product.

The discharge from the third grind dewatering screen and first stage fiber wash are combined, creating a slurry with a density of approximately 8 Baumé. This slurry is thickened with a Merco H36 centrifuge. This centrifuge operates at 2600 rpm and is fitted with No. 24 size nozzle. The overflow from the centrifuge is used as process water for steeping (also known as mill water), while the underflow slurry, having a Baumé of 12, is fed to a second H36 centrifuge (referred to as primary centrifuge). The starch-protein in the fed slurry is separated by the primary centrifuge. The primary centrifuge operates at 2200 rpm and is fitted with No. 24 nozzle to yield an underflow and overflow slurry. The overflow slurry is protein-enriched containing approximately 60% (db) protein, while the underflow slurry is starch enriched. The protein enriched overflow slurry from this centrifugation is then further dewatered by centrifugation with a third Merco H36 centrifuge operating at 2600 rpm, dewatered on a rotary drum filter and dried using a flash drier. This results in the dried protein rich product, also known as corn gluten meal. The starch enriched-slurry originating from the underflow of the second Merco H36 centrifuge described above is passed through a twelfth stage Dorr-Oliver clam shell hydrocyclone starch wash battery. The starch wash battery is designed such that a counter-current flow between the starch enriched stream entering the first stage of the battery and potable water entering at the twelfth stage of the battery is achieved. Each stage starch wash stage has several 10 millimeter hydroclones arranged in parallel fashion. Typical feed pressure to each starch wash stage, except the twelfth stage, is 6.2 bar (90 psi); the feed pressure on the twelfth stage is 8.27 (120 psi). Purified starch with a slurry density of 23 Baumé is recovered as underflow from the twelfth stage of the starch wash battery, also known as starch slurry or starch product of corn wet milling.

Further information regarding the wet milling of corn is found in Technology of Corn Wet Milling and Associated Processes p. 69-125, Paul H. Blanchard, Elsevier Science Publishers B. V. Amsterdam.

### Example 9

The procedure of Example 8 for the production of starch from a starch containing seed is followed except sound wave generated by an ultrasonic processor is used to treat the previously sonified and steeped starch containing seed instead of using grind mills. After steeping, the steeped seed is passed through a cylinder fitted with multiple ultrasonic processor radial probes operating at a frequency of 30 kHz and an intensity of 300 W/cm². Starch, protein, germ and fiber are separated and recovered by subsequent operations as indicated in Example 8. It is expected that similar results will be obtained.

### Example 10

A fermentation feedstock can be prepared as described below. Any of the starch comprising products produced by any of the previous examples, specifically Examples 1 through 9, may be optionally hydrolyzed to form a fermentation feedstock to be incorporated into a fermentation media. The starch slurry may be hydrolyzed to any extent to form a hydrolyzed starch, including to dextrose. The starch slurry may be hydrolyzed by any manner. For example, starch slurry may be hydrolyzed by subjecting the starch slurry to acid hydrolysis. Typically acids to be used will include inorganic acids such as hydrochloric acid and the like. Elevated temperatures increase the rate of hydrolysis and may be varied over a wide range depending on the degree of hydrolysis desired. Acid hydrolysis is limited in the extent of starch hydrolysis possible. If one wishes to exceed that level of hydrolysis, one must use other means of hydrolysis such as enzymatic digestion of the starch with starch hydrolyzing enzymes. An exemplary process for carrying out starch hydrolysis by acid hydrolysis is described as follows:

a) starch slurry with a density of about 23 Baumé is provided;

b) the pH of the slurry is adjusted to about 1.8 with about 22 Baumé hydrochloric acid;

c) the slurry with pH of about 1.8 is introduced into a Dedert continuous acid conversion system (Olympia Fields, Ill., USA) at 146° C. (295° F.) for 18 minutes, after treatment in the conversion system the starch is hydrolyzed to 85 dextrose equivalents (DE); and

e) the pH of the converted starch is then adjusted to 4.8 with 10% soda ash and cooled. Further information regarding starch hydrolysis is found in Technology of Corn Wet Milling and Associated Processes p. 217-266, Paul H. Blanchard, Elsevier Science Publishers B. V. Amsterdam.

### Example 11

As an example of a method for producing a fermentation feedstock from the starch product produced in any of the previously listed examples, specifically Sxamples 1-9, the following is provided. The starch comprising product produced by the previous examples may be optionally hydrolyzed to form a fermentation feedstock to be incorporated into a fermentation media. The starch slurry may be hydrolyzed to any extent to form a hydrolyzed starch, including to dextrose. An enzyme hydrolysis of starch is performed in the following method of liquefaction.

Liquefaction: Water is added to the starch to adjust dry solid content to 35%. The pH of slurry is adjusted to 5.5 using sodium hydroxide solution. Calcium chloride is added to the slurry to have the minimum of 5 ppm of free calcium. TERMAMYL SUPRA enzyme, (a trademarked amylase available from Novozymes North America, Inc) is added to this pH adjusted slurry at the amount of 0.4 liter per metric ton of starch dry solids. Then, the mixture is heated in a continuous jet cooker to 108° C. (226.4° F.) and held for 5 minutes in a pressurized vessel. Then the cooked mixture is cooled to 95° C. (203° F.) and held for 100 minutes. A starch hydrolyzate with a DE of 8 to 12 is produced. Further information regarding starch hydrolysis is found in Technology of Corn Wet Milling and Associated Processes p. 217-266, Paul H. Blanchard, Elsevier Science Publishers B. V. Amsterdam.

### Example 12

As an example of a method for producing a fermentation feedstock from the starch products produced in any of the previously listed examples, specifically examples 1-9 that have been treated with a liquefaction process, according to example 10 or 11, the following is provided. The starch comprising product produced by the previous examples may be optionally hydrolyzed to form a fermentation feedstock to be incorporated into the fermentation media. The starch slurry may be hydrolyzed to any extent to form a hydrolyzed starch, including to dextrose. An enzyme hydrolysis of a liquefied starch produced by the methods of example 10 and 11 is performed in the following method:

Saccharification: Starch hydrolyzate from the Example 10 or 11 consisting of a liquefaction step is cooled to 60° C. and the dry solid content is adjusted to 32% by adding water. The pH of this diluted hydrolyzate is adjusted to 4.1-4.3 using sulfuric acid. DEXTROZYME E enzyme (a traded mixture of amyloglucosidase and pullunase available from Novozymes North America, Inc) is added at the amount of 0.7 liters per metric ton of dry solids and then the mixture is held for 40 hours. Dextrose content of 95-97%, on the dry solid basis, is achieved. Further information regarding starch hydrolysis is found in Technology of Corn Wet Milling and Associated Processes p. 217-266, Paul H. Blanchard, Elsevier Science Publishers B. V. Amsterdam.

The invention has been described with references to various specific and illustrative embodiments and techniques. However, one skilled in the art will recognize that many variations and modifications may be made while remaining within the spirit and scope of the invention.

We claim:

1. A process for producing a sonicated plant seed comprising:
a. providing a plant seed; and
b. sonicating the plant seed in the presence of a solvent at an intensity of at least 95 W/cm² and at a frequency ranging from about 16 to about 100 kHz.

2. The process according to claim 1 further comprising recovering product resulting from the sonication.

3. The process according to claim 2 wherein the recovered product includes a protein, a carbohydrate, a fiber, a vitamin, an antioxidant, a pharmaceutical, or an oil.

4. The process according to claim 1 wherein the plant seed is sonicated at an intensity of at least 95 W/cm² to about 500 W/cm².

5. The process according to claim 1 wherein the plant seed is sonicated at an intensity of about 100 W/cm² to about 300 W/cm².

6. The process according to claim 1 wherein the plant seed is sonicated at a frequency ranging from about 16 to about 40 kHz.

7. The process according to claim 1 wherein the plant seed is sonicated at an intensity of 95 W/cm² to 127 W/cm².

8. The process according to claim 6 wherein the frequency is 24 kHz.

9. The process according to claim 1 wherein the solvent is selected from the group consisting of an aqueous solvent, an organic solvent, and a mixture thereof.

10. The process according to claim 9 wherein the solvent is an aqueous solvent.

11. The process according to claim 10 wherein the aqueous solvent is water.

12. The process according to claim 9 wherein the solvent is an organic solvent.

13. The process according to claim 12 wherein the organic solvent is selected from the group consisting of methanol, ethanol, butanol, propanol, iso-propanol, hexane, isohexane, and acetone.

14. The process according to claim 1 wherein the plant seed is selected from the group consisting of a cereal and an oil seed.

15. The process according to claim 14 wherein the cereal is selected from the group consisting of corn (maize), rice, sorghum, barley, and wheat.

16. The process according to claim 15 wherein the cereal is corn.

17. The process according to claim 15 wherein the cereal is rice.

18. The process according to claim 14 wherein the oil seed is selected from the group consisting of soybean, peanut, rapeseed (canola), cottonseed, safflower, sunflower, caster bean, and linseed (flax).

19. The process according to claim 18 wherein the oil seed is soybean.

20. The process according to claim 18 wherein the oil seed is peanut.

21. The process according to claim 18 wherein the oil seed is canola.

22. The process according to claim 1 further comprising sonicating the sonicated plant seed at an intensity of at least 95 W/cm² and a frequency ranging from 16 to 100 kHz.

23. A process for producing a starch product comprising using a sonicated plant seed of claim 1 wherein the plant seed is a starch containing plant seed.

24. A process for producing a starch product comprising using a sonicated plant seed of claim 22 wherein the plant seed is a starch containing plant seed.

25. A process for producing a fermentation feedstock comprising using the sonicated plant seed of claim 1.

26. A process for producing a fermentation feedstock comprising using the sonicated plant seed of claim 22.

27. A process for using the sonicated plant seed of claim 1 as a fermentation feedstock.

28. A process for using the sonicated plant seed of claim 22 as a fermentation feedstock.

29. A fermentation feedstock produced according to claim 25.

30. A fermentation feedstock produced according to claim 26.

31. The process according to claim 22 further comprising recovering product resulting from the sonication.

32. The process according to claim 31 wherein the recovered product includes a protein, a carbohydrate, a fiber, a vitamin, an antioxidant, a pharmaceutical, or an oil.
